(19) United States
(12) Patent Application Publication
(10) Pub. No.: US 2006/0264201 A1
(43) Pub. Date: Nov. 23, 2006

(54) Identity mapping mechanism in wlan access control with public authentication servers

(75) Inventor: Junbiao Zhang, Beijing (CN)

Correspondence Address: THOMSON LICENSING INC., PATENT OPERATIONS, PO BOX 5312, PRINCETON, NJ, 08543-5312, US

(73) Assignee: THOMSON LICENSING S.A., Boulogne (FR)

(21) Appl. No.: 10/548,578

(22) PCT Filed: Mar. 4, 2004
(86) PCT No.: PCT/US04/06566

§ 371 Date: Jun. 1, 2006

Related U.S. Application Data
(60) Provisional application No. 60/453,329, filed on Mar. 10, 2003.

(51) Int. Cl. H04M 1/66

(52) U.S. Cl. 455/411

(57) ABSTRACT

A method for improving the security of a mobile terminal in a first communications network environment by redirecting the browser request, embedding a session identification inside an HTTP request and matching two HTTP sessions using such a session identification in the authentication server. The access point processes the web request from the mobile terminal such that a session identification becomes embedded in the universal resource locator. Additionally a mapping between this session identification and the media access control address or the internet protocol address of the mobile terminal is maintained in the WLAN. When the authentication server notifies the access point about the authentication result, the session identification is used to uniquely identify the mobile terminal. All these operations are transparent to the mobile terminal.

### RELATED APPLICATION

This application claims the benefit of U.S. Provisional Application No. 60/453,329, filed Mar. 10, 2003 and is incorporated herein by reference.

### 1. FIELD OF THE INVENTION

The invention provides an apparatus and a method to improve the security and access control over a wireless local area network (“WLAN”) by embedding session identification within an authentication request and matching two sessions using the identification in a security process within the authentication server.

### 2. DESCRIPTION OF RELATED ART

The context of the present invention is the family of wireless local area networks or (WLAN) employing the IEEE 802.1x architecture having an access point (AP) that provides access for mobile devices and to other networks, such as hard wired local area and global networks, such as the Internet. Advancements in WLAN technology have resulted in the publicly accessible hotspots at rest stops, cafes, libraries and similar public facilities. Presently, public WLANs offer mobile communication device users access to a private data network, such as a corporate intranet, or a public data network such as the Internet, peer to peer communication and live wireless TV broadcasting. The relatively low cost to implement and operate a public WLAN, as well as the available high bandwidth (usually in excess of 10 Megabits/second) makes the public WLAN an ideal access mechanism through which mobile wireless communications device users can exchange packets with an external entity, however as will be discussed below, such open deployment may compromise security unless adequate means for identification and authentication exists.

When a user attempts to access service within a public WLAN coverage area, the WLAN first authenticates and authorizes the user, prior to granting network access. After authentication, the public WLAN opens a secure data channel to the mobile communications device to protect the privacy of data passing between the WLAN and the device. Presently, many manufacturers of WLAN equipment have adopted the IEEE 802.1x standard for deployed equipment. Hence, this standard is the predominant authentication mechanism utilized by WLANs. Unfortunately, the IEEE 802.1x standard was designed with private LAN access as its usage model. Hence, the IEEE 802.1x standard does not provide certain features that would improve the security in a public WLAN environment.

FIG. 1 illustrates the relationships among three entities typically involved in an authentication in a public WLAN environment: a mobile terminal (MT), a WLAN accesses point (AP), and the authentication server (AS), which may be associated with a particular service provider, or virtual operator. The trust relationships are as follows: the MT has an account with AS and thus they mutually share a trust relationship, the WLAN operator and the operator owning the AS (referred to as “virtual operator” thereafter) have a business relationship, thus the AP and the AS have a trust relationship. The objective of the authentication procedure is to establish a trust relationship between the MT and the AP by taking advantage of the two existing trust relationships.

In a web browser based authentication method, the MT directly authenticates with the AS, using the web browser through an Hyper Text Transfer Protocol Secured Sockets (HTTPS) protocol and ensures that the AP (and anyone on the path between the MT and the AS) cannot trespass upon or steal confidential user information. While the channel is secure, the AP cannot determine the result of the authentication unless explicitly notified by the AS. However, the only information the AS has related to the MT is its Internet protocol or IP address at the other end of the HTTPS session. When firewalls, NAT servers, or web proxies are electronically situated between the MT and the AS, which is normally the case with the virtual operator configuration, such information cannot be employed to identify the MT.

Most existing WLAN hot spot wireless providers use web browser based solution for user authentication and access control, which proves convenient to the user and does not require any software download on the user device. In such a solution, the user is securely authenticated through HTTPS by a server, which in turn notifies the wireless AP to grant access to the user. Such an authentication server AS may be owned by the WLAN operator or any third party providers, such as Independent Service Providers (ISPs), pre-paid card providers or cellular operators, referred to as more broadly virtual operators.

In the prior art, the authentication is achieved through a communication between the user and the authentication server, through a secure tunnel. As such the AP does not translate the communication between the user and the authentication server. Consequently, a separate communication referred to as authorization information between the AP and the authentication server AS must be established so that the AP receives the authorization information.

Access control in the AP is based on MAC addresses or IP addresses, and therefore, the authentication server AS can use the mobile terminal MT IP address (the source address of the HTTPS tunnel) as the identifier when it returns the authentication result to the AP. This approach succeeds, if neither a firewall nor a Network Address Translation (NAT) between the AP and the authentication server AS exists, such as illustrated by firewall FW and the local server LS. In general and when virtual operators are present, the authentication server is located outside of the wireless access network domain, and thus outside of the firewall FW, and often the HTTPS connection used for authentication actually goes through a web proxy. The source address that the authentication server AS receives would be the web proxy's address, which cannot be used to identify the mobile terminal MT user device and therefore cannot be used by the AP in assuring a secure connection.

In the current web browser based authentication solutions, the WLAN and the authentication server AS are part of the same entity, thus the foregoing problem may not be an issue. However, as the virtual operator concept becomes more widely deployed for hot spot WLAN access, the problem of identifying authentication sessions without solely relying on source IP address becomes more pressing, because the potential for hacking into computers would rise accordingly.

### SUMMARY OF THE INVENTION

The invention provides a method for improving the security and access control of a mobile terminal in a WLAN environment to overcome the problems noted above. The method according the invention includes embedding session identification (session ID) inside an HTTP request and matching two HTTP sessions using such a session ID in the authentication server to thereby uniquely identify the mobile terminal associated with an authentication message. An access request may be redirect to a server in the WLAN that provides the session identification, stores mapping data that maps the session identification to the mobile terminal, and generates a web page having the session ID embedded therein, that is transmitted to the mobile terminal.

The access point processes the web request from the mobile terminal such that a session ID is embedded in the universal resource locator (URL). Additionally the access point maintains a mapping between this session ID and the MAC address of the MT. When the authorization server notifies the access point that it has received the authentication result, the session ID is thereafter used to uniquely identify the mobile terminal.

In one embodiment of the invention, the method for controlling access to a wireless local area network (“WLAN”), comprises the steps of: receiving a request to access the WLAN from a mobile terminal disposed within a coverage area of the WLAN; associating a session ID with an identifier associated with the mobile terminal, and storing data mapping the session ID to the identifier associated with the mobile terminal; transmitting an authentication request, which includes the session ID, to an appropriate authentication server; receiving an authentication message, which includes the session ID, concerning the mobile terminal from the appropriate authentication server; correlating the received authentication message to the mobile terminal in response to the stored mapping data; and controlling access by the mobile terminal to the WLAN in response to the received authentication message.

The identifier may be any parameter or characteristic of the mobile terminal that can be used to uniquely identify the mobile terminal. The identifier associated with the mobile terminal may comprise the MAC address associated with the mobile terminal or an IP address associated with the mobile terminal. The session ID may be embedded in a web page generated by the WLAN, e.g., in the universal resource locator associated with the submit button to the HTTPS session with the authentication server.

### BRIEF DESCRIPTION OF THE DRAWINGS

The invention is best understood from the following detailed description when read in connection with the accompanying drawing. The various features of the drawings are not specified exhaustively. On the contrary, the various features may be arbitrarily expanded or reduced for clarity. Included in the drawings are the following figures:

FIG. 1 is a block diagram of a communications system for practicing the method of the present principles for authenticating a mobile wireless communications device.

FIG. 2 is a flow diagram of the method of the present invention.

### DETAILED DESCRIPTION OF THE INVENTION

In the figures to be discussed the circuits and associated blocks and arrows represent functions of the method according to the present invention which may be implemented as electrical circuits and associated wires or data busses, which transport electrical signals. Alternatively, one or more associated arrows may represent communication (e.g., data flow) between software routines, particularly when the present method or apparatus of the present invention is implemented as a digital process.

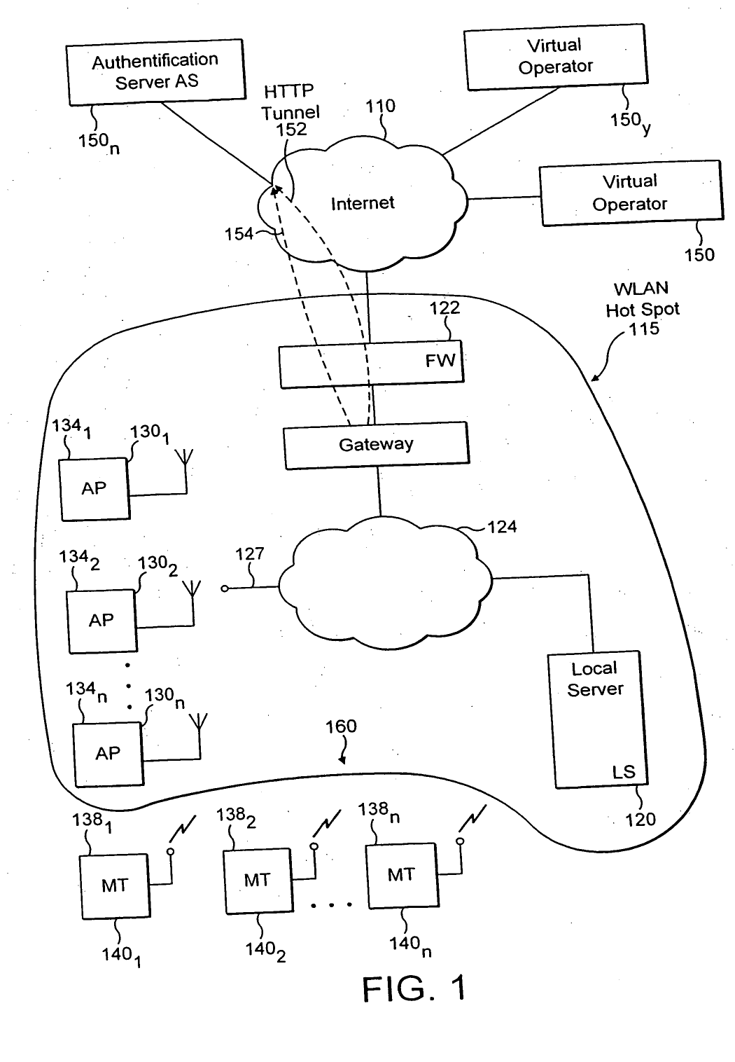

In accordance with FIG. 1, one or more mobile terminals represented by 140₁ through 140ₙ communicates through an access point 130₁ through 130ₙ and associated computers 120 with an authentication server 150, typically for purposes of accessing a secured data base or other resource that requires a high degree of security from unauthorized entities, such as would be hackers.

As further illustrated in FIG. 1, the IEEE 802.1x architecture encompasses several components and services that interact to provide station mobility transparent to the higher layers of a network stack. The IEEE 802.1x network defines AP stations such as access points 130₁₋ₙ and mobile terminals 140₁₋ₙ as the components that connect to the wireless medium and contain the functionality of the IEEE 802.1x protocols, that being MAC (Medium Access Control) 134₁₋ₙ, and corresponding PHY (Physical Layer) (not shown), and a connection 127 to the wireless media. Typically, the IEEE 802.1x functions are implemented in the hardware and software of a wireless modem or a network access or interface card. This invention proposes a method for implementing an identification means in the communication stream such that an access point 130₁₋ₙ compatible with the IEEE 802.1x WLAN MAC layers for downlink traffic (i.e. from the an authentication server to the mobile terminal such as a laptop) may participate in the authentication of one or more wireless mobile devices 140₁₋ₙ, a local server 120 and a virtual operator, which includes an authentication server 150.

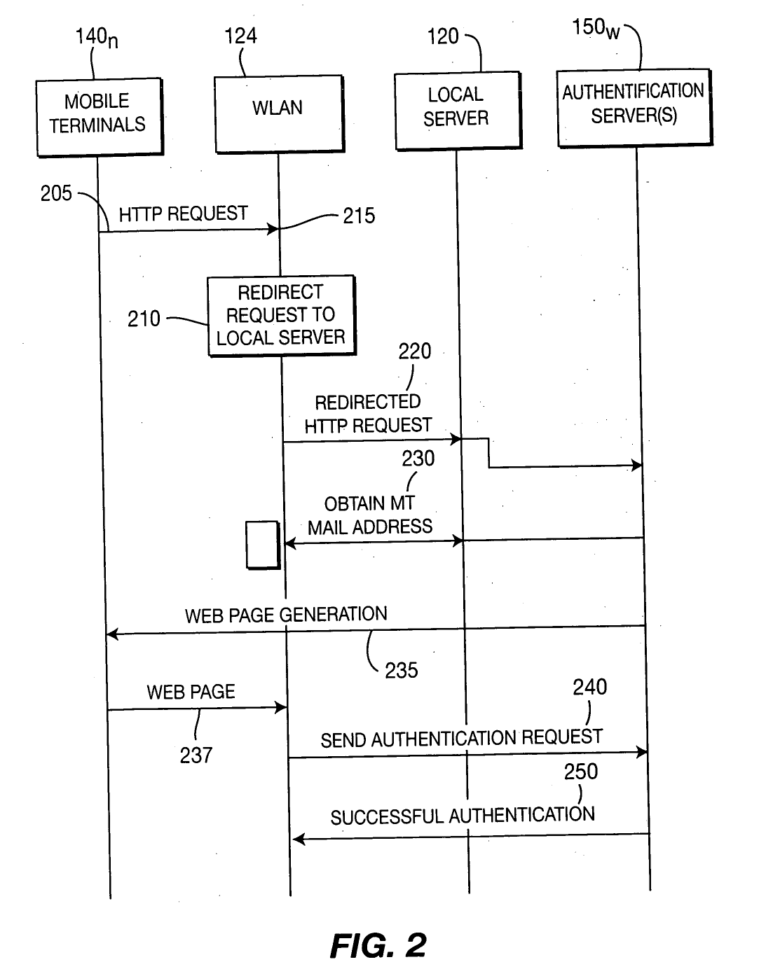

In accordance with the present principles, an access 160 enables each mobile terminal 140₁₋ₙ, to securely access a WLAN 124, which includes the plurality of access points and local server 120, by authenticating both the mobile terminal itself, as well as its communication stream in accordance with the IEEE 802.1x protocol. The manner in which the access 160 enables such secure access can best be understood by reference to FIG. 2, which depicts the sequence of interactions that occurs over time among a mobile wireless communication device, say mobile terminal 140ₙ, the public WLAN 124, the local web server 120, and the authentication server 150ₙ. When configured with the IEEE 802.1x protocol, the access point 130ₙ of FIG. 1 maintains a controlled port and an un-controlled port, through which the access point exchanges information, with the mobile terminals 140₋ₙ. The controlled port maintained by the access point 130ₙ serves as the entryway for non-authentication information, such as data traffic to pass through the access point between the WLAN 124 and the mobile terminals 140₋ₙ. Ordinarily, the access point 130₋ₙ keeps the respective controlled port closed in accordance with the IEEE 802.1x protocol until authentication of the mobile wireless communications device. The access points 130₋ₙ always maintain the respective uncontrolled port open to permit the mobile terminals 140₋ₙ to exchange authentication data with the authentication server 150ₙ.

With reference to FIG. 2, a method in accordance with the present invention for improving the security of a mobile terminal in 140ₙ in a WLAN 124 is generally accomplished by redirecting 210 a HTTP browser request 205, embedding a session ID 215 inside the HTTP request 205 and matching two HTTP sessions using such a session ID 215 in the authentication server 150ₙ.

More particularly, the method of the present invention processes an access request from a mobile terminal 140ₙ through the WLAN 124, access point 130ₙ (web request 205 from the mobile terminal 140ₙ ), by embedding in the (URL) the session ID 215.

With reference to FIG. 2, a method in accordance with the present invention for improving the security of a mobile terminal in 140ₙ in a WLAN environment 124 redirects 220 the browser request to the local web server 120. The local server 120 obtains the MAC address 138ₙ associated with the mobile terminal 140ₙ, generates a session ID 215, and stores a mapping associating the MAC address 138ₙ and the session ID 215. The WLAN 124 maintains a mapping between the session ID 215 and a MAC address 138ₙ of the mobile terminal 140ₙ. The local server 120 generates a web page, requesting a user of the mobile terminal 140 to select a virtual operator, thereby selecting an appropriate authentication server 150, embedding the session ID 215 into a web page 237 for transmission. The local server 120 also returns 230 the MAC address 138ₙ having an associated session ID 215 embedded in the URL address.

The mobile terminal responds by embedding the URL associated with a submit button to start an HTTPS session with an authentication server 150, whereby the WLAN 124 sends the authorization request 240 having the session ID 215 embedded in the request, through HTTPS to the authentication server 150ₙ. Thereafter, the authentication server 150ₙ processes the session ID 215 and communicates to the access point 130ₙ via the WLAN 124, the session ID 215 confirming 250 a successful authentication. The process also includes the step of receiving by the access point the MAC address associated with the session ID 215 one or more changes an access control filter and thereby allowing all communications having the MAC address to be received by the mobile terminal 140ₙ. The foregoing process allows encrypting the communication between the access point 130ₙ and the mobile terminal 140ₙ to insure a more secure access control.

When the access point 130ₙ and the authentication server 150ₙ are separated by firewall 122, or NAT servers, it is not possible for the authentication server 150ₙ to directly communicate with the access points 130₁₋ₙ. This problem can be solved by having the access point 130ₙ first contact the authentication server 150ₙ to establish a communication context. When the access point 130ₙ detects that one of the mobile terminal 140₁₋ₙ starts the HTTPS communication with the authentication server 150ₙ the associated access point 140ₙ sends the authentication server 150ₙ a message with the associated session ID 215 indicating that the authentication server 150ₙ return the authentication result for that session.

The access point 140ₙ has several options available in establishing contact with the authentication server 150ₙ. By way of example, it may utilize HTTPS with the added benefit of the access point 140ₙ and the authentication server 150ₙ utilizing an existing protocol to mutually authenticate each other and secure the communication between them. One disadvantage in this approach is that HTTPS is carried over Telecommunication Control Protocol (TCP), thus it requires that the TCP connection remain open, until the mobile terminal 140ₙ is authenticated. This may put resources into a queue on the access point 140ₙ.

By way of example, another alternative is to utilize the RADIUS protocol, which is based on UDP, for the communication between the access point 130ₙ and the authentication server 150. The benefit of this approach is that no connections need to be maintained between the access point 130ₙ and the authentication server 150, while the mobile terminal 140ₙ is being authenticated. This approach may not work in all firewall 122 configurations, because particular firewalls only permit HTTP, HTTPS, FTP, and TELNET to pass through.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

1. A method for controlling access to a communications network, comprising the steps of:
receiving a request to access the communications network from a mobile terminal disposed within a coverage area of the communications network;
associating a session identification with an identifier associated with the mobile terminal, and storing data mapping the session identification to the identifier associated with the mobile terminal;
transmitting from the communications network an authentication request, which includes the session identification, to an appropriate authentication server outside the communications network;
receiving in the communications network an authentication message, which includes the session identification, concerning the mobile terminal from the appropriate authentication server;
correlating the received authentication message to the mobile terminal in response to the stored mapping data; and
controlling access by the mobile terminal to the communications network in response to the received authentication message.

2. The method according to claim 1, wherein the associating step comprises associating the session identification with a media access control address of the mobile terminal, and storing data mapping the session identification to the media access control address of the mobile terminal.

3. The method according to claim 1, wherein the associating step comprises associating the session identification with an internet protocol address associated with the mobile terminal, and storing data mapping the session identification to the internet protocol address associated with the mobile terminal.

4. The method according to claim 1, further comprising the steps of
transmitting a request to mobile terminal, the request containing the session identification,
receiving from the mobile terminal a response to said request, said response including the session identification embedded therein, and an indicator of the appropriate authentication server for authenticating the mobile terminal.

5. The method according to claim 4, wherein the step of transmitting a request to the mobile terminal comprises generating a web page requesting that the mobile terminal select an appropriate authentication server, embedding the session identification in the web page, and transmitting the web page to the mobile terminal.

6. The method according to claim 5, wherein the session identification is embedded in the universal resource locator associated with a submit button to start an HTTPS session.

7. The method according to claim 6, further comprising the step of establishing a communications context between the communications network and the authentication server when the HTTPS session is started between the mobile terminal and the authentication server, whereby the authentication server sends the authentication message to the communications network.

8. A method for according to claim 1, further comprising:
redirecting the request from an access point of the network to a local server associated with the communications network, the local server associating the session identification with the identifier associated with the mobile terminal, and storing data mapping the session identification to identifier associated with the mobile terminal.

9. (canceled)

10. (canceled)

11. (canceled)

12. (canceled)

13. A first communications network, comprising:
an access point for communicating with one of a plurality of mobile terminals through a wireless communications channel;
a local server coupled to the access point; and
means, coupled to the access point and the local server, for coupling the first communications network to a second communications network, the second communications network being coupled to one of a plurality of authentication servers, wherein in response to an access request by a mobile terminal disposed in the coverage area of the first communications network.
the local server associates a session identification to an identifier associated with the requesting mobile terminal, and stores mapping data that maps the session identification to the identifier associated with the requesting mobile terminal,
transmits an authentication request including the session identification to an appropriate authentication server of said plurality of authentication servers coupled to said second communications network,
correlates a received authentication message from the appropriate authentication server to the requesting mobile terminal, and
controls access by the mobile terminal to the first communications network in response to the received authentication message.

14. The first communications network according to claim 13, wherein the identifier associated with the requesting mobile terminal corresponds to an media access control address of the requesting mobile terminal.

15. The first communications network according to claim 13, wherein the identifier associated with the requesting mobile terminal corresponds to an internet protocol address associated with the requesting mobile terminal.

16. The first communications network according to claim 13, wherein the access point transmits the session identification to the mobile terminal, and receives from the mobile terminal an authentication request, which includes the session identification embedded therein, to be transmitted to the authentication server.

17. The first communications network according to claim 16, wherein the local server generates a web page requesting that the mobile terminal select an appropriate authentication server, and embeds the session identification in the web page, and the access point transmits the web page to the mobile terminal.

18. The first communications network according to claim 17, wherein the local server embeds the session identification in the universal resource locator associated with a submit button to start an HTTPS session.
